(19) United States
(12) Patent Application Publication
(10) Pub. No.: US 2012/0203151 A1
(43) Pub. Date: Aug. 9, 2012

(54) ARM, WRIST AND HAND TREATMENT DEVICE AND METHOD

(76) Inventor: Paul Kleiman, Culver City, CA (US)

(21) Appl. No.: 12/969,540

(22) Filed: Dec. 15, 2010

Related U.S. Application Data
(63) Continuation-in-part of application No. 11/608,792, filed on Dec. 8, 2006, now abandoned.

(51) Int. Cl. A61H 15/00

(52) U.S. Cl. 601/112

(57) ABSTRACT

The device disclosed herein and its method of use offers an accessible, portable device and method for treating carpal tunnel and repetitive stress syndrome sufferers by providing repeated deep tissue massage for a human forearm, wrist and hand. The device comprises at least a pair of massage members, urged together within a frame that may be stabilized on a table top by one hand of a user, between or through which the user's treatment hand, wrist and forearm are inserted and withdrawn for the duration desired. The intensity of the massage may be altered by a compression member which, after being set by the user, does not require the user's continued effort to maintain during massage. In one embodiment of the device, the pair of opposed massage members is maintained in its opened position once the user's arm has been fully inserted, allowing withdrawal of the arm without applying any further pressure. This provides for an effective device and method of massage for an edemic arm.

### CROSS REFERENCE TO RELATED APPLICATION

This application is a Continuation-In-Part of co-pending U.S. Non-Provisional application Ser. No. 11/608,792 filed on 8 Dec. 2006, and claims priority from U.S. provisional patent application No. 60/749,272 filed 9 Dec. 2005, both by Paul L. Kleiman, applicant herein. These applications are incorporated by reference.

### BACKGROUND

The present device and method of the disclosure is in the field of therapeutic arm, wrist and hand massage devices and methods, and more particularly directed to a readily obtainable device and easy to use method for treating both Repetitive Stress Syndrome and Carpal Tunnel Syndrome. Both ailments are the caused by unrelieved muscle tension causing nerve compression and pain. Massaging muscles induces them to relax, and therefore persons suffering from one or both ailments may be effectively treated by knowledgeably targeting, massaging and relaxing the pain-causing appropriate muscle groups.

“Carpal Tunnel Syndrome” takes its name from the “tunnel” in the wrist shared by both tendon and nerves. This opening accommodates the tendons running from the forearm and elbow to the finger flexing muscles, flexor digitorum, as well accommodating the median nerve of the arm. Overworking the finger muscles causes them to knot or stay in a contracted state, thereby causing the attached tendon running through the carpal tunnel to impinge upon the median nerve. A patient with this condition typically first experiences pain or numbness on the first and second fingers and occasionally the thumb.

“Repetitive Stress Syndrome,” occurs when over-contracted muscles of the forearm and wrist compress the median, ulnar and radial branches of the brachial nerve, and a patient's symptoms typically include numbness or tingling in the fingers, and cramping or pain in the hand and wrist. There can be a decrease in fine motor dexterity when the hands and wrists become tired. Repetitive Stress Syndrome may be commonly diagnosed in secretaries, word processors, massage therapists, artists (especially painters), writers, surgeons, and musicians (notably guitar and bass players and pianists). People who spend extended time using a computer keyboard and/or mouse, such as patent attorneys, are often so diagnosed.

The Repetitive Stress symptoms result from these flexor and extensor muscles tightening, thereby effectively shortening the connected tendons in the forearms, wrists and hands. The shortened tendons compress the median, ulnar and radial nerves that travel from their origin in the spinal chord at the brachial plexus to their ends in the fingers. A single nerve fiber may extend the entire distance from origin to end, and be painfully compressed at several sites. The resultant forearm nerve compression is experienced by the patient as finger or hand pain.

Several peer reviewed journal articles, including but not limited to those listed hereinbelow, have reported increased mobility and decreased pain in patients suffering from compressed nerve induced hand pain when such patients received non-invasive treatment including massage, yoga, carpal bone manipulation and median nerve manipulation. See Carpal Tunnel Syndrome: A daily self-massage for stretching tendons alleviated pain following one month.; Field, T. et al, (in review); Yoga-based intervention for carpal tunnel syndrome: a randomized trial., Garfinkel M S, et al. PMID 9820263 [PubMed—indexed for MEDLINE]; An investigation to compare the effectiveness of carpal bone mobilization and neurodynamic mobilization as methods for treatment for carpal tunnel syndrome, Tal-Akabi, A, Rushton A., PMID 11052900 [PubMed—indexed for MEDLINE].

Therefore, a device or method that relaxes the tightened muscles that cause nerve compression relieves both the cause and the pain of carpal tunnel and repetitive stress syndrome sufferers. Deep muscle massage relaxes tightened muscles, and permits them to return to their “at rest” position, relieving nerve compression.

Practical roadblocks to obtaining effective deep tissue massage treatment are time and money: Such massage therapy requires repeated sessions given by a specially trained, and therefore well compensated, massage therapist. Unfortunately, many patients are unwilling or unable to afford or even find a qualified therapist, or else they may be misdiagnosed and are subjected to unnecessary and unsuccessful surgery.

Another ailment effectively treated through massage is edema. Edema is the abnormal accumulation of lymph or other internal fluids beneath the skin or in other body cavities. Edema of the limbs is also effectively treated by massaging the affected area. The direction of massage for this kind of edema must be towards the affected person's heart, away from the end of the edemic limb.

Others have provided devices and methods for massage. In United States Patent Application No. US 2005/0159688 A1, by Sakamoto et al., entitled MASSAGER AND MASSAGING METHOD, a two roller leg massager is disclosed for increasing circulation in the lower leg by drawing a massage device upwards from the foot toward the knee, changing intensity of the massage pressure by changing the angle at which the user pulls Sakamoto's device up the leg. The device of U.S. Pat. No. 5,792,081 issued to Cross entitled LIMB MASSAGER discloses a device for massaging forearm and wrist affected by repetitive strain injury, but requires the user to strain the hand not being treated by maintaining or increasing the grip of the un-treated hand to increase massage pressure. Further, the Cross device is strapped to or held under one of the user's legs during treatment which may be awkward for a business setting or difficult to accomplish.

Engel, in U.S. Pat. No. 5,643,182, and McClenathen (U.S. Pat. No. 2,230,890) also disclose massagers. Engel discloses a massager comprising incremental pressure adjustment before massage begins. McClenathen discloses a similar device that may be variably adjusted before use.

However none of these devices provides a standalone device easily used on a desk or in an office environment. Further, neither device provides variable massage force that, once set, does not need to be maintained by the user. Still further, none of these devices provides a device for one way massage of the arm toward the heart of the user for treating edema.

### BRIEF DESCRIPTION OF THE DISCLOSURE

The device disclosed herein and its method of use offers an accessible, portable device and method for treating carpal tunnel and repetitive stress syndrome sufferers and for those suffering from edema in their arms by providing repeated massage for a human forearm, wrist and hand.

### DRAWINGS

FIG. 1 is a front and right side perspective of the device of the disclosure.

FIG. 2 is a front elevation of the device of the disclosure showing the two massage members urged close together.

FIG. 3 is a front elevation of the device of the disclosure showing the two massage members forced apart.

FIG. 4 is a side elevation of the device of the disclosure.

FIG. 5 is a front and right side exploded perspective of the device of the disclosure.

FIG. 6 is a top, front and right side exploded perspective of the device of the disclosure.

FIG. 7 is a cut away front elevation of the device of the disclosure showing the two massage members urged close together.

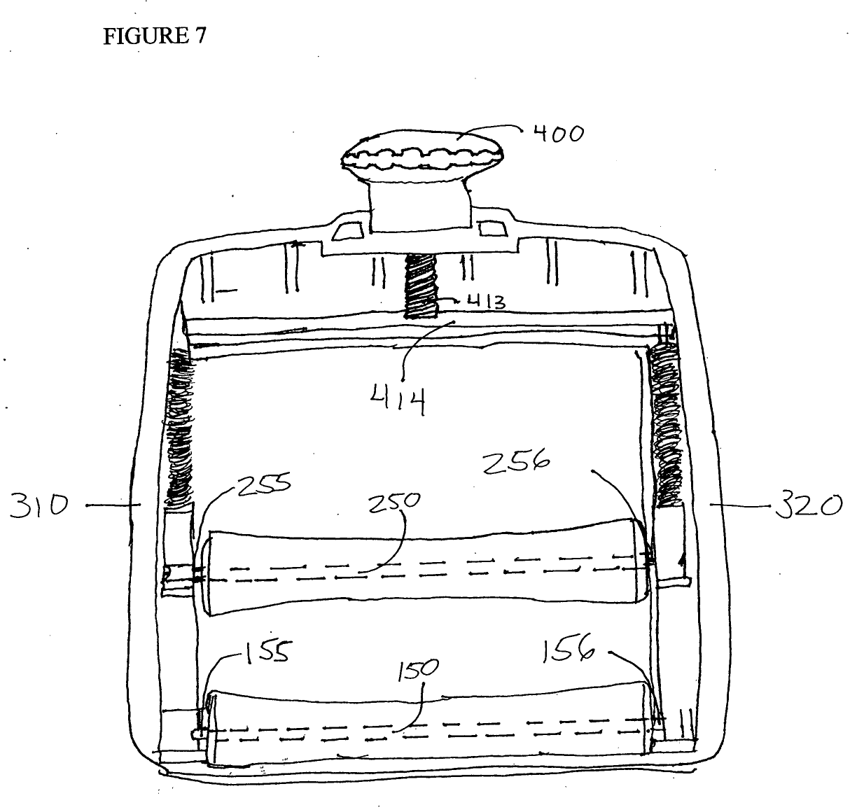

FIG. 8 is a front elevation of the device of the disclosure showing the two massage members forced apart.

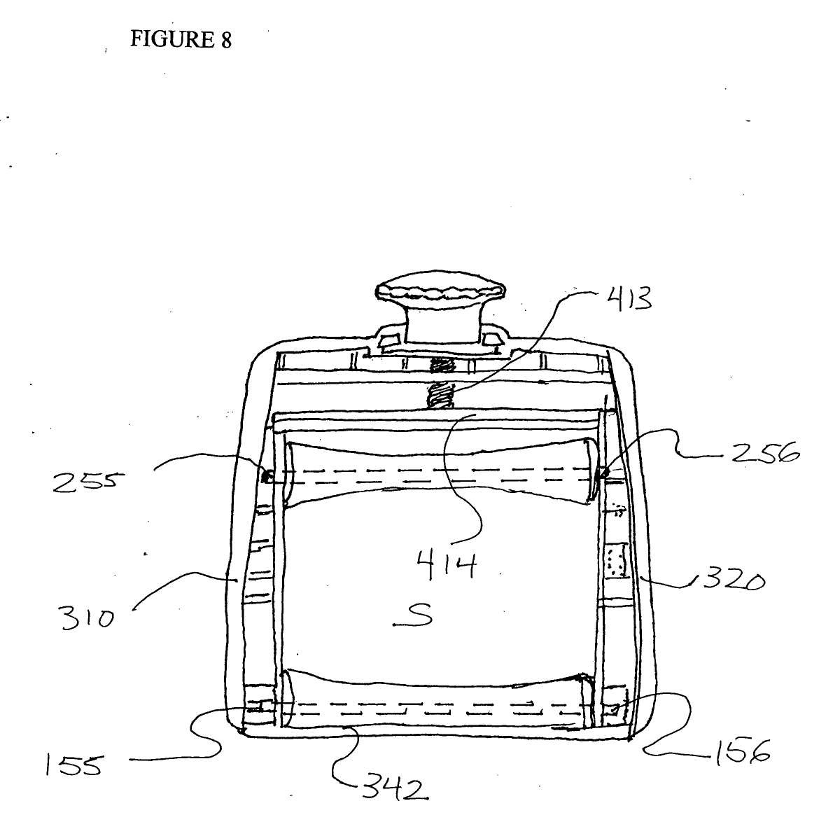

FIG. 9 is a front and right side perspective of the device of the disclosure showing the two massage members forced apart by a user's arm and the catch-and-hold member.

### DETAILED DESCRIPTION

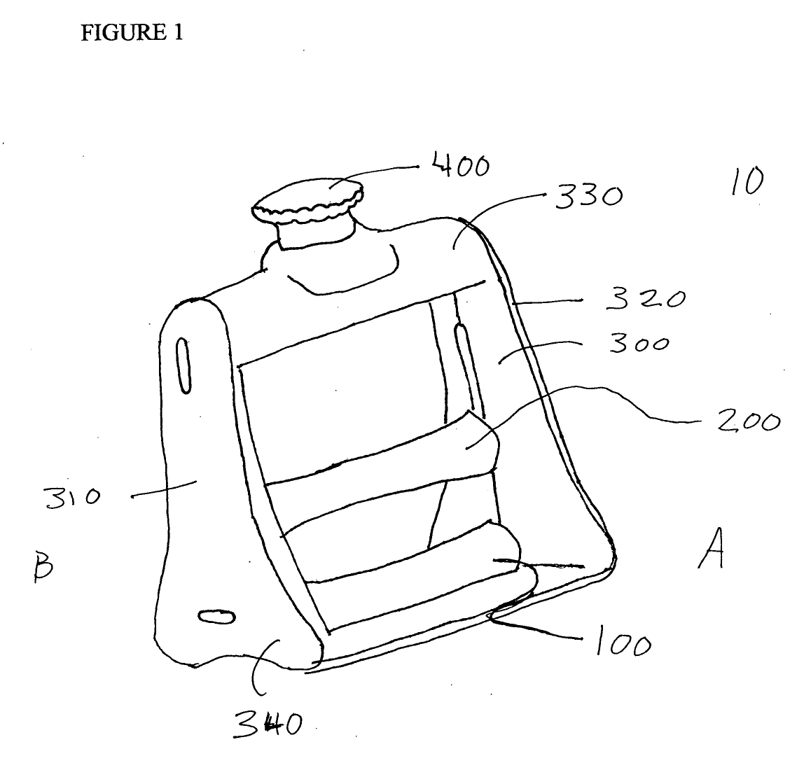

The reader is referred now to the Figures disclosed above for reference. FIG. 1 discloses the device 10 comprising a first massage member 100, a second massage member 200 and a frame 300. A portion of a compression member 400 is also disclosed. The frame 300 has a first side 310, a second side 320, a top 330 and a base 340. Additionally, each device 10 comprises two faces A, B. Each massage member 100, 200 rotates freely about an axle 150, 250. Each of these axles 150, 250 has a first end 155, 155 and a second end 156, 256. The first 100 and second 200 massage members are disposed relative to the frame's sides 310, 320 so that the first ends of their respective axles 155, 255 are disposed within the first side of the frame 310, and the second ends 156, 256 are disposed within the second side of the frame 320. The massage members 100, 200 may be moved relative to one another within the frame 300.

In one embodiment, the position of the first massage member 100 is fixed relative to the frame 300 close to the frame's base 340 but, like the second massage member 200, is always freely rotatable about its axle 150. In this embodiment, the second massage member 200 is slideably fixed in the frame 300 as the first and second ends of its axle 255, 256 are slideably disposed within the first and second sides of the frame 310, 320, respectively.

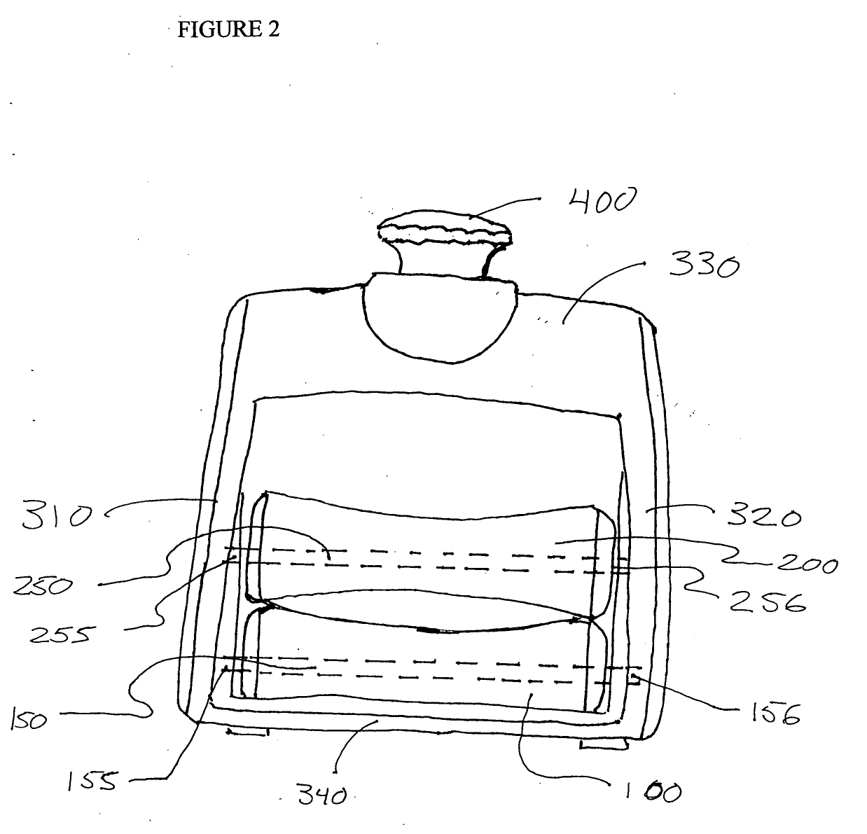

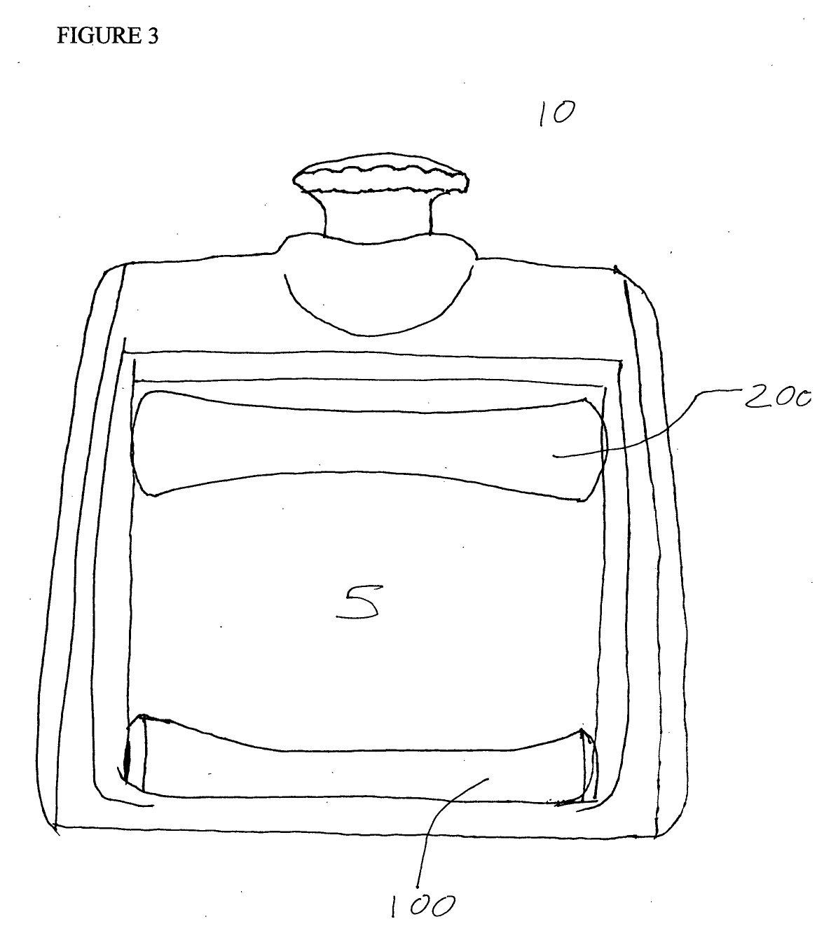

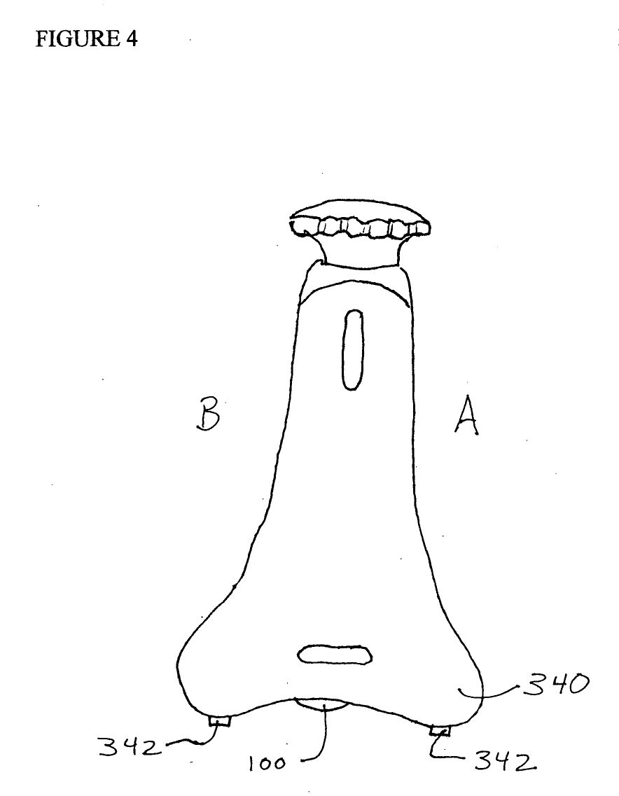

FIG. 2 discloses the device with the first and second 100, 200 massage members urged together into a closed position by the compression member 400 into a closed position. In FIG. 3, the first and second 100, 200 massage members are forced apart into an open position as when a human forearm (not shown) is inserted between the members 100, 200 against the force exerted by the compression member 400 during use of the disclosed device 10. FIG. 4 is a side elevation disclosing the frame base 340 adapted to support the device 10 in a standing position. The base 340 may be further adapted to comprise non-skid “feet” 342 or, in place of feet, suction cups (not shown).

The space S defined by the separation between the massage members 100, 200 is adapted to accept a human forearm. The shapes of the massage members 100, 200 may vary so long as they define a space S that is adapted to accept a human forearm. One method of using the disclosed device is described. A user having a stabilizing arm, wrist and hand and a treatment hand, wrist and forearm positions the device 10 where the user can comfortably practice the method of the disclosure, for example, on the top of a desk at which the user sits.

One face A is positioned to admit insertion of the treatment hand between the massage members 100, 200. So positioned, the user stabilizes the device 10 using the stabilizing arm, wrist and forearm by holding the frame 300, preferably by holding the top of the frame 330. While so stabilizing the device 10 manually or by using suction cups, the user inserts the treatment hand between the massage members 100, 200, forcing them apart by thereby to form a space S. The user continues to insert the treatment hand into and beyond space S to permit as much of the user's treatment wrist and treatment forearm to travel between the massage members 100, 200 as desired. The user then withdraws the treatment arm back out through space S.

If the feet 342 are replaced by by suction cups (not shown) and the device 10 is secured to a surface by these suction cups during use, the user does not need to hold or to stabilize the frame 330. Use of suction cups in this way permits a user to massage one arm or hand without placing strain on the other arm, which may already be in a relaxed state. The free hand is then not strained, contracted or tensed by holding the massage device 10 in place to effect massage. No other device appears to function “hands free” in this manner.

The user's treatment arm moving through S exerts a frictional force on the massage members 100, 200. This force causes the members' 100, 200 rotation about their respective axles 150, 250. The massage members 100, 200 are concurrently urged toward one another by the compression member 400 during this rotation. The user's treatment arm is thereby massaged by moving between the at least two freely rotatable massage members 100, 200 urged together by the compression member 400 while the device 10 is stabilized by the user's stabilizing hand or by using suction cups on the frame 330. When the user has finished massaging the treatment arm, the position, function and relative movement of the stabilizing and treatment arms may be reversed.

The shape of the massage members 100, 200 is not limited to rollers or spheres. Each of the massage members 100, 200 may comprise at least one solid of revolution or surface of revolution having its axis of revolution substantially identical to its axle 150, 250. The surface of the massage member, regardless of its overall shape, may comprise a smooth surface, a surface of a regular pattern, a surface of a random pattern, or any combination of surfaces that effect massage when the massage member rolls over a human forearm during use of the disclosed device 10.

Additionally, a massage member may comprise any matter capable of substantially retaining the shape of a solid or revolution or surface of revolution. By way of example only and not limitation, such matter may comprise wood, air, gaseous matter, liquid matter, solid matter, gel, steel, rubber, glass, plastic, ceramic or any synthetic matter. The common characteristic it that matter's adaptability to inclusion in a member that freely rotates about its axle.

It is also a desired characteristic that the surface of the massage member is not significantly eroded or broken down by massage lotions or oils that a user may use while practicing the disclosed method, or by cleaning the massage members after such use.

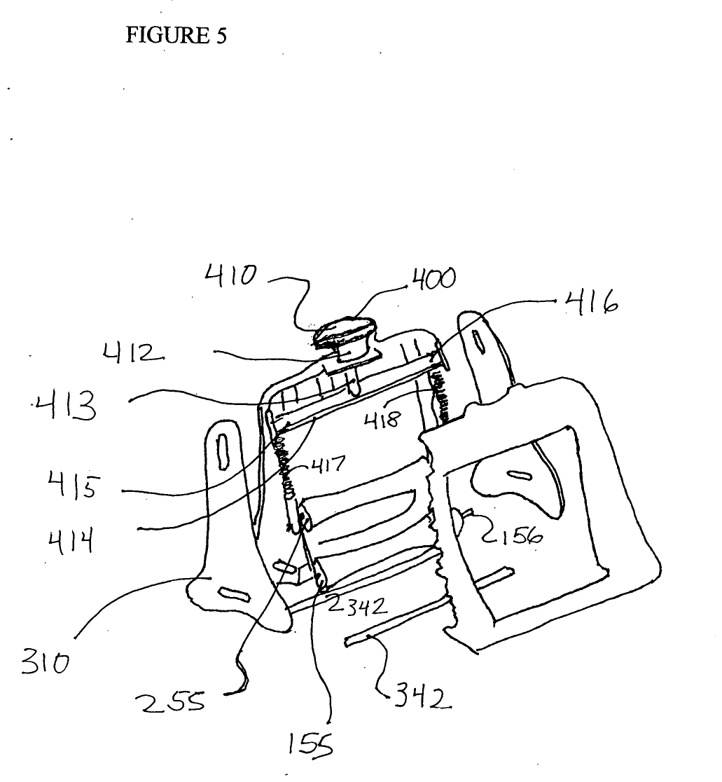

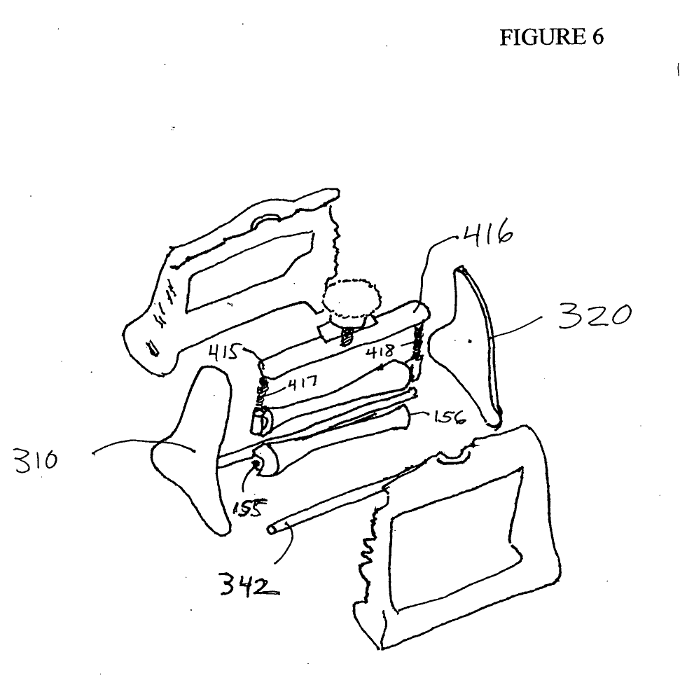

FIGS. 5 and 6 are exploded perspective views of the disclosed device revealing the entire compression member 400, illustrated in part in FIGS. 1-4. The compression member 400 comprises at least one compressor 410 adapted to urge the second massage member 200 toward the first massage member 100. In the illustrated embodiment of FIG. 5, the compressor 410 comprises a handle 412 fixedly bearing a downwardly disposed member 413 attached to a cross piece 414 having two ends 415, 416. Two springs 417, 418, adapted to urge the first 210 and second 220 axle ends of the second massage member 200, respectively, toward the two axle ends of the first massage member 110, 120, respectively, are disposed within the sides of the frame 310, 320. By pressing the compression member handle 412 toward the frame base 440, a user may more forcefully urge the second massage member 200 toward the first massage member 100 and thereby exert a stronger massaging force upon a user's arm as that arm is moved in an out of space S.

In one embodiment, the downwardly disposed member 413 is a bolt, rotatably fixed in the crosspiece 414, and extending through and adapted to mate with a bolt hole 413a (not shown) defined by the frame top 330. The user effects increased compression by tightening said bolt 413. In another embodiment, not shown, the downwardly disposed member 413 is a notched rod adapted to catch and be held within an opening defined by the frame top 330. In another embodiment, not shown, the downwardly disposed member is adapted to mate with a ratchet. A person skilled in the art will recognized that many devices designed to transmit increased force and to be temporarily fixed in a position transmitting this increased force may be substituted for the downwardly disposed member 413.

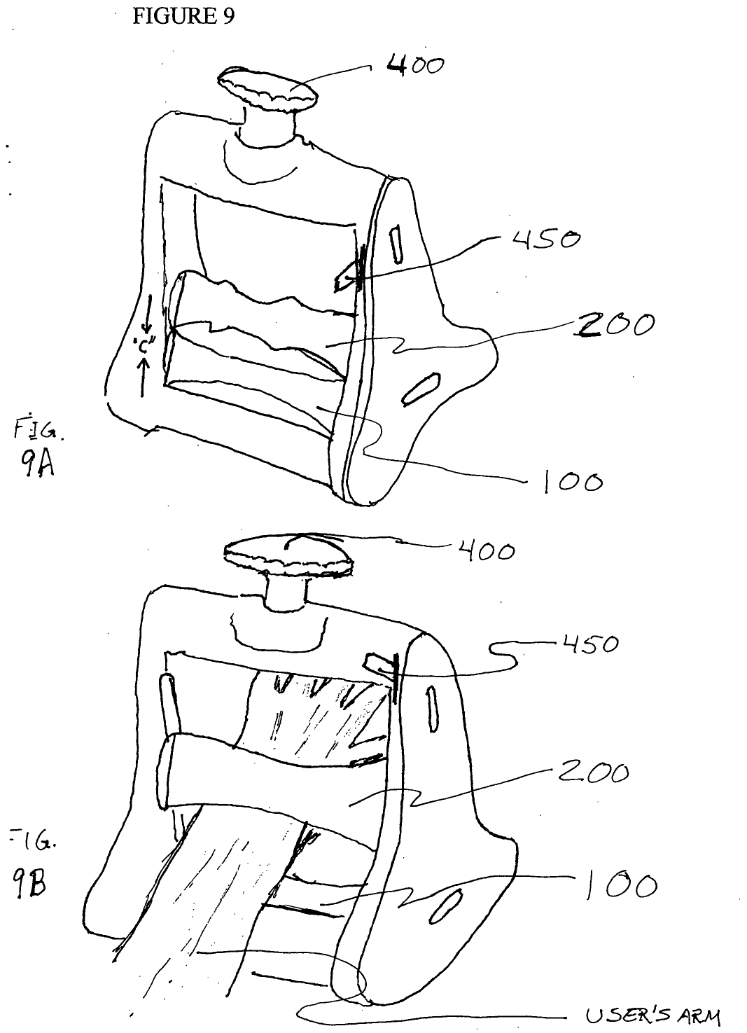

For treatment of a user's edemic arm, the massage must be only in one direction, namely from the end of the arm toward the heart. When a user inserts an edemic arm between massage members 100 and 200 beginning with the ends of the fingers and proceeding up the arm, the space between massage members 100, 200 increases until it comes to an open position for that arm, designated as “O” on FIG. 9B. By inserting the arm between the massage members 100, 200, it is massaged toward the user's heart. For the edema treatment to be effective, the massage members 100, 200 must not exert pressure against the user's arm as it is withdrawn from between the massage members 100, 200.

FIG. 9 illustrates the device as adapted to be used for treating an edemic arm. In this embodiment, the disclosed device comprises a capture-and-hold member 450 adapted to capture at least one end of the axle 210 of the second massage member 200 when that member 200 reaches the open position. In one embodiment, this hold member 450 comprises a lever that extends through an opening defined either by face A or face B of the frame 300. One end of the lever may be positioned by a user in a free position as depicted in FIG. 9A and moved to a capture-and-hold position as depicted in FIG. 9B. In its free position, FIG. 9A, the hold member 450 does not contact the axle 210 of the second massage member. When the hold member 450 is positioned to a capture-and-hold position as shown in FIG. 9B, a section of that member 450 within the frame (not shown) holds the axle 210 and maintains the open position of the massage member 200, thereby permitting the user to withdraw the massaged arm without causing any additional pressure on the arm as it is withdrawn from the device 10.

The method disclosed comprises using the disclosed device as described above, namely by positioning one face A of the device 10 and inserting the treatment hand between the massage members 100, 200 while stabilizing the device 10 using the stabilizing arm, wrist and forearm by holding the frame 300, preferably by holding the top of the frame 330; while so stabilizing the device 10, inserting the treatment hand between the massage members 100, 200, thereby forcing them apart by thereby to form a space S, continuing to insert the treatment hand into and beyond space S to permit as much of the user's treatment wrist and treatment forearm to travel between the massage members 100, 200 as desired; and then withdrawing the treatment arm back out through space S. The user may increase the amount of force with which the first 100 and second 200 compression members are urged together by adjusting the compression member 400. The method disclosed herein is effective regardless of the shape or surface treatment of the massage members used.

I claim:

1. A stand alone variable pressure massage device comprising:
a. a first massage member and a second massage member, each massage member comprising an axle about which that massage member freely rotates, and each axle having a first end and a second end;
b. a frame comprising at least a bottom, a first side and a second side, the first side adapted to receive the first ends of the axles of the first and second massage members and the second side adapted to received the second ends of the axles of the first and second massage members;
c. the first massage member's first end of its axle and second end of its axle fixedly attached to the frame, and the first and second axle ends of the second massaging member slideably attached to the frame; and
d. at least one variable pressure compression member adapted to fit within the frame and adapted to urge the second massage member toward the fixedly attached first massage member by contacting and urging the first end of the members' respective axles toward one another and the second ends of the members' respective axles towards one another.

2. The device of claim 1 further adapted to provide a change in the force of compression by urging the first massage member toward the second massage member.

3. The device of claim 1 further adapted to provide a connector between the first end of the axle of the second roller and a first compression member and to provide a connector between the second end of the axle of the second roller and the first compression member.

4. The device of claim 1 further adapted to provide at least one compression member that comprises at least two springs, a handle, a downwardly disposed member connected to the handle, a crosspiece with two ends, each end of the crosspiece positioned to come into contact with one of the at least two springs, all elements of the compression member remaining inside the frame during normal use of the disclosed device save the handle and downwardly disposed member.

5. The device of claim 1 further comprising a compression member chosen from the group comprising gel, liquid or elastic solid.

6. The device of claim 1 further adapted to comprise an outer side adapted to stand on a desk while being used for massage, the outer side further comprising at least one slip resistant surface.

7. The device of claim 1 further adapted to comprise an outer side adapted to stand on a desk while being used for massage without user support, the outer side further comprising suction cups.

8. The device of claim 1 further adapted to comprise at least one massage member that is a solid of revolution having its axis of revolution substantially parallel to its axle.

9. A stand alone variable pressure massage device comprising:
a. a first massage member and a second massage member, each massage member comprising an axle about which that massage member freely rotates, and each axle having a first end and a second end;
b. a frame comprising at least a bottom, a first side and a second side, the first side adapted to receive the first ends of the axles of the first and second massage members and the second side adapted to received the second ends of the axles of the first and second massage members;
c. the first massage member's first end of its axle and second end of its axle fixedly attached to the frame, and the first and second axle ends of the second massaging member slideably attached to the frame;
d. at least one variable pressure compression member adapted to fit within the frame and adapted to urge the second massage member from an open position toward a closed position adjacent the fixedly attached first massage member by contacting and urging the second member's axles toward the first member's axles; and
e. a capture-and-hold member movably attached to the frame and adapted to capture and hold at least one axle of the second massage member in the member's open position.

10. The device of claim 9 adapted to provide at least one compression member that comprises at least two compression effectors; a handle; a downwardly disposed member fixedly connected to the handle, which so disposed member extends through an opening defined in the frame top and which disposed member and frame top opening are adjustably connectable to maintain a set position of the disposed member relative to the opening; the downwardly disposed member adapted to connect with a crosspiece comprising at least two ends, each said end adapted to contact one of the at least two compression effectors, all elements of the compression member remaining inside the frame during normal use of the disclosed device save the handle and downwardly disposed member.

11. The device of claim 9 further comprising at least one slip resistant surface on the bottom of the frame.

12. The device of claim 9 further adapted to stand independently and to comprise at least one suction device on the bottom of the frame.

13. The device of claim 9 wherein the least two massage members comprise solids of rotation, said solids having their respective axles of rotation substantially parallel to their respective axles.

14. A method of massaging a treatment hand, wrist and forearm comprising:
a. stabilizing a device comprising at least one pair of massage members, each massage member comprising an axle about which that massage member freely rotates, and each axle having a first end and a second end; a frame comprising at least a bottom, a first side and a second side, the first side adapted to receive the first ends of the axles and the second side adapted to received the second ends of the axles of the at least one pair of massage members; and at least one compression member adapted to fit within the frame and adapted to urge the at least one massage member toward the at least another massage member by contacting and urging the first ends of the members' respective axles toward one another and the second ends of the members' respective axles towards one another;
b. inserting a treatment hand, wrist and forearm in between the at least two massage members urged together by the at least one compression member; and
c. withdrawing the treatment hand, wrist and forearm from between the massage members,
d. repeating the inserting and withdrawing steps until an effective massage is accomplished.

15. The method of claim 19 further comprising adjusting the compression member to a set position before or during the massage, the set position being maintained by the device disclosed without further exertion by a user to maintain that position.
